(19) United States
(12) Patent Application Publication
(10) Pub. No.: US 2025/0368188 A1
(43) Pub. Date: Dec. 4, 2025

(54) CONFIGURABLE PRECISION PARKING ASSIST SYSTEM

(71) Applicant: Adeia Guides Inc., San Jose, CA (US)

(72) Inventor: Dhananjay Lal, Englewood, CO (US)

(21) Appl. No.: 18/680,304

(22) Filed: May 31, 2024

(51) Int. Cl. B60W 30/06; B60W 50/14; B60W 60/00

(52) U.S. Cl. CPC B60W 30/06; B60W 50/14; B60W 60/001; B60W 2554/20; B60W 2554/80; B60W 2720/24

(57) ABSTRACT

Systems and methods for generating guidance information for parking a vehicle within a parking area are disclosed herein. At a first time, parking configuration mode is initiated for a vehicle parked in a first position. During the parking configuration mode, a representation of the parking area's physical environment is generated based on sensor data. Selections of one or more objects within the physical environment are received to be used as parking reference points. Distances between respective reference points and the vehicle are determined and stored as first distance data. At a second time, parking assist mode is initiated for guiding the vehicle to the first position. Second distance data between the reference points and the vehicle in a second position are determined. The second distance data is compared to the first distance data and based on the comparison, guidance information for parking in the first position is generated for output.

### BACKGROUND

The present disclosure relates to systems and methods for improving parking assist and navigation systems for parking a vehicle within a designated parking area.

### SUMMARY

Generating parking guidance data for parking a vehicle presents several challenges for a parking assist system, in particular for tight and/or crowded parking environments. For example, a crowded parking environment such as a home's car garage may be filled with various objects such as bicycles, tools, workout equipment, home appliances and storage boxes that make it difficult for a parking assist system to accurately calculate a parking trajectory, thus increasing the risk of damaging the vehicle or the objects around it. Furthermore, in the case of many car garages, the system may need to provide parking instructions for parking the vehicle in a specific parking position that provides a user with sufficient space to complete activities such as retrieving bicycles, using workout equipment, retrieving construction/gardening equipment and sliding out shelf drawers. The parking assist system may therefore need to account for sufficient clearances between obstructions and the vehicle while parking such that any activities within the parking location can be performed without requiring the vehicle to be re-parked. If the parking location is particularly crowded and the parking assist system must account for various precise clearances, it may take several parking attempts before the vehicle finds a particular parking position. Parking in a tight or crowded parking environment may even cause increased wear and tear to the vehicle's steering system and tires if a driver makes several attempts to maneuver their car into the particular position during parking sessions.

In one approach, the parking assist system may rely on a GPS signal for generating parking guidance. However, GPS navigation may be unavailable in an enclosed structure with no access to satellite signal. Moreover, GPS positioning data may not be accurate enough for generating guidance for precise parking locations (e.g., positioning a vehicle with centimeter level precision in a parking garage).

Another approach to providing parking guidance in tight or crowded parking environments includes the installation of physical barriers such as ceiling-mounted parking balls, wall-mounted bumpers, or floor stoppers. Physical barriers, however, offer limited navigation assistance by only providing one reference point that a driver must utilize to subjectively determine whether every part of the vehicle is aligned in a specific parking position within the crowded parking environment. Parking parameters such as vehicle angle within the parking environment therefore are difficult to determine solely using physical barriers. This approach also requires contact with a physical reference point during every parking attempt, possibly causing additional wear and tear to the exterior of the vehicle. Furthermore, physical barriers are not included with a user's vehicle therefore requiring additional purchases and cumbersome installations to integrate into a respective parking environment. In another approach, a parking assist system may be based on wall mounted sensors (e.g., ultrasonic, radar, etc.) or lasers installed in a respective parking area. While a sensor or laser provides more objective guidance by precisely measuring distance and providing instant feedback (e.g., in the form of a beep or visual signal), this approach nonetheless requires additional purchasing and installation steps. Also, for parking parameters such as vehicle angle, the environment would need to have multiple sensors installed within the parking environment in order to accurately provide parking directions to a specific parking position that enables the user to complete certain daily activities within the respective parking environment.

In another approach, the vehicle exterior may be equipped with proximity sensors (e.g., ultrasonic, radar, etc.) and cameras. Such an approach enables a parking assist system to provide parking guidance for safely parking the vehicle in a parking location without the need for an additional purchase or installation of secondary equipment such as the physical barriers or wall mounted sensors/lasers mentioned above. While this approach is effective in an average parking location, its effectiveness is reduced in crowded environments with scattered and nonuniform surfaces to measure distance from. Furthermore, this approach cannot be configured to measure the distances of specific objects within a parking environment (e.g., the distance between the vehicle and a bike rack), and instead merely provides an indication of the vehicle's proximity to the closest object. With this approach, a user is still required to subjectively determine whether they have precisely parked their vehicle into the specific parking position that enables them to complete certain daily activities within the respective parking environment.

In further approaches, some parking assist systems may utilize three-dimensional (3D) imaging to provide parking guidance. These parking assist systems may generate a 3D construction of the parking environment which can be stored in memory for later reference. Such approaches do not consider, however, the difference between rigid, stationary, and non-rigid, non-stationary objects in a crowded parking location. Thus, these approaches suffer from the same flaw as the proximity sensor-based parking assist systems mentioned above, in that they only provide visual or audible feedback based on the distance between the vehicle and the closest object. While this ensures collision avoidance, it does not ensure that a parking assist system provides parking guidance that is specifically tailored to a specific parking position within a crowded parking environment. Moreover, this approach for utilizing 3D constructions does not consider how non-stationary objects may move between parking sessions. For example, if the parking environment includes several non-stationary objects, this approach fails when the positions of these non-stationary objects change. The parking assist system is unable to match the modified parking environment to the stored 3D construction and requires recalibration to account for the non-stationary objects that have moved. In a parking environment such a garage where objects are constantly moved around, recalibrating the parking assist systems would be a constant issue. There therefore is a need for a precision parking method that leverages the advanced sensors and computing power of the vehicle to enable a user to consistently park their vehicle in a specific position of a crowded parking location based on specific predefined stationary reference points.

To solve these problems, methods and systems are disclosed herein for providing a parking assist system that generates parking guidance for a specific parking position based on distances to preselected parking reference points. In some embodiments, the parking assist system initiates, at a first time, a parking configuration mode for a vehicle parked in a first position in a parking area. When in parking configuration mode, the system generates for display on a user interface of a device at least one representation of a physical environment of the parking area, based on sensor data captured by at least one sensor. In some approaches, the parking assist system then receives, via the user interface, a selection of a one or more objects from the at least one representation of the physical environment of the parking area to be used as parking reference points for future parking of the vehicle in the first position and determines and causes to be stored first distance data based on a first set of distances, wherein each respective distance of the first set of distances corresponds to a distance from the vehicle in the first position to a respective object of the one or more objects in the parking area. At a second time, the parking assist system then initiates a parking assist mode for assisting in parking the vehicle in the first position and may determine second distance data based on a second set of distances, wherein each respective distance of the second set of distances corresponds to a distance from the vehicle in a second position to a respective object of the one or more objects in the parking area. Based at least in part on comparing (a) the second distance data determined in the parking assist mode at the second time and (b) the stored first distance data generated in the parking configuration mode at the first time, the parking assist system generates for output guidance information for parking the vehicle in the first position.

Such aspects enable a parking assist system to provide precise guidance for parking in a specific parking position of a crowded parking environment by leveraging the sensors of the vehicle and stored distance data corresponding to the specific parking position. In some embodiments, the specific parking position may be a position where the vehicle can safely park while all activities and items within the parking location are still easily accessible. Configuring the parking assist system to provide parking guidance based on customized reference points (e.g., stationary non-movable objects), as opposed to reference points closest to the vehicle, enables the parking assist system to provide precise parking guidance to a specific parking position. Since the parking assist system references specific reference points, it can still provide parking guidance and does not require recalibration even if some objects of the crowded parking environment change between parking sessions. When the vehicle is eventually aligned into the specific parking position during a parking session, the vehicle can provide a recognizable signal as an indication of the alignment, therefore taking any element of subjectivity out of the parking process for the driver.

In some embodiments, location data based on the geographical coordinates of the parking area is caused to be stored during the parking configuration mode. Such aspects enable the parking assist system to automatically initiate parking assist mode when it determines, based on the geographical coordinates of the parking area, that the vehicle is within a proximity of the parking area.

In some embodiments, the guidance information includes recommended driving directions for repositioning the vehicle from the second position to the first position within the parking area. In some approaches, these driving directions are generated for output via a display of the vehicle (i.e., the infotainment display or heads-up display). By providing precise parking guidance to the specific first position in a crowded parking environment, such aspects enable an efficient parking process from the second position to the first position within the parking area.

In some implementations, the parking assist system is integrated into an autonomous vehicle. In such implementations, the vehicle may be configured to automatically follow the recommended driving directions to reposition the vehicle from the second position to the first position within the parking area. In such aspects, the parking assist system is enabled to communicate with the autonomous driving system of the vehicle to move the vehicle into the first position of the parking area without requiring any additional user driving inputs.

In some embodiments, comparing (a) the second distance data determined in the parking assist mode at the second time and (b) the stored first distance data generated in the parking configuration mode at the first time includes comparing various distances from respective sides of the vehicle. For example, the parking assist system may compare a front distance stored at the first time with a front distance determined at the second time, wherein each of the front distances corresponds to a distance from a front sensor (e.g., an image sensor or LiDAR sensor) of the vehicle to a respective object of the one or more objects in the parking area. The parking assist system may perform the same process for every side of the vehicle (e.g., back, side) to ensure that the vehicle is precisely aligned in the first position of the parking area.

Some embodiments of the parking assist system include utilizing the various compared distances of respective sides of the vehicle to determine an angular displacement of the vehicle at the second time. The parking assist system then compares the angular displacement of the vehicle at the second time to the angular displacement of the vehicle at the first time. If the angular displacements do not match, the parking assist system generates for output the guidance information for changing the angular displacement of the vehicle.

In some approaches, the parking assist system determines that the plurality of detected objects are static objects. In such approaches, the parking assist system may generate for display on the user interface of the device at least one representation of the physical environment of the parking area. In some embodiments, the at least one representation may include generated AR overlays over at least a portion of each respective object of the one or more objects to indicate that the one or more objects are static objects that are candidates for being used as parking reference points. Such aspects enable the parking assist system to provide further guidance for a driver regarding which portions of the parking area are most suitable as parking reference points.

In some embodiments, the parking assist system determines that the one or more objects are static objects based on comparing the locations of the one or more objects in the physical environment of the parking area at various times using historical image data. For example, a refrigerator could be interpreted as movable compared to a stationary structural pillar within a garage. However, if the parking assist system detects the refrigerator in the same position within the historical image data it determines that the refrigerator is a static object.

In some implementations, the parking assist system determines that a particular object of the one or more objects determined to be a static object is obstructed. The parking assist system therefore generates the respective AR overlay over an unobstructed portion of the particular object. In some approaches, the distance between the particular object and the vehicle is determined based on the unobstructed portion of the particular object. Such aspects provide a clear indication to the system, and also the user, of which portions of an object will be used to gauge distance between the object and the vehicle. For example, if a pillar within the parking area is frequently used as a stand for a bicycle, the AR overlay is only generated over the upper portion of the pillar unobstructed by the bicycle to indicate that the parking assist system will only use the upper portion to gauge distance.

In some embodiments, receiving, via the user interface, the selection of the one or more objects from the at least one representation of the physical environment of the parking area also includes receiving a request, via the user interface, to reduce the respective AR overlay over a particular object. In such embodiments, reducing the respective AR overlay causes the parking reference point for the particular object to change to a part of the particular object covered by the reduced AR overlay. For example, as mentioned above, the pillar within the parking area may be frequently used as a stand for a bicycle; however, the bicycle may not be there during parking configuration mode. Such aspects, therefore, enable the user to modify the AR overlay of objects to account for possible future obstructions such as the bicycle.

In some approaches, the parking assist system determines at the second time that a reference point of a particular object that was unobstructed during the parking configuration mode is now obstructed during the parking assist mode. In such approaches, the parking assist system may detect an unobstructed portion of the particular object as an alternative reference point and, based on the first distance data, calculate a distance between the unobstructed portion of the particular object and the vehicle when parked at the first position. The parking assist system may then add the calculated distance to the first distance data. Such aspects enable the parking assist system to utilize an object as a reference point even if the originally stored directions based on the AR overlay did not account for a possible obstruction. For example, the user may place their bicycle in front of a second pillar that is not normally used as a bike stand. The parking assist system can, nonetheless, determine that the upper portion of the pillar is unobstructed and use the unobstructed portion to calculate a distance corresponding to the first position even if the user did not originally modify the AR overlay for the respective pillar.

In some implementations, the vehicle is a first vehicle, and a parking assist system of a second vehicle stores third distance data corresponding to a third position. In such implementations, the first position may be accessible through a first garage door and the third position may be accessible through a second garage door. Thus, based on determining that the first vehicle is in a proximity of the first position, the first vehicle may cause the first garage door to open and, based on determining that the second vehicle is in a proximity of the third position, the second vehicle may cause the second garage door to open.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows a schematic illustration for determining and storing a specific parking position for a vehicle during parking configuration mode and subsequently guiding the vehicle to the specific parking position during a subsequent parking session, in accordance with some embodiments of this disclosure;

FIG. 2A shows a schematic illustration for determining the normal distance and offset distance between a vehicle and a reference object during parking configuration mode, in accordance with some embodiments of this disclosure;

FIG. 2B shows a schematic illustration for utilizing the distances determined during configuration mode to compare them to distances determined during parking assist mode, in accordance with some embodiments of this disclosure;

FIG. 3A shows a schematic illustration for determining distances between a vehicle and notable portions of a reference object during parking configuration mode, in accordance with some embodiments of this disclosure;

FIG. 3B shows a schematic illustration for utilizing the distances determined during configuration mode to compare them to distances determined during parking assist mode, in accordance with some embodiments of this disclosure;

FIG. 4 shows an illustrative example for displaying a representation of a parking environment and receiving user selections of objects via a user interface, in accordance with some embodiments of this disclosure;

FIG. 5A shows an illustrative example for displaying parking guidance information during parking assist mode, in accordance with some embodiments of this disclosure;

FIG. 5B shows an illustrative example for displaying parking guidance information during parking assist mode, in accordance with some embodiments of this disclosure;

FIG. 6 is a block diagram of an illustrative example of a vehicle architecture, in accordance with embodiments of the disclosure;

FIG. 7 is an example of an illustrative system implementing the parking assist application, in accordance with embodiments of the disclosure, in accordance with embodiments of the disclosure;

FIG. 8 is a sequence diagram of the transfer of instructions between a user and a vehicle's parking assist system during parking configuration mode, in accordance with embodiments of the disclosure; and

FIG. 9 is an illustrative flowchart for a process of aligning a vehicle into a specific parking position during parking assist mode, in accordance with embodiments of the disclosure.

### DETAILED DESCRIPTION

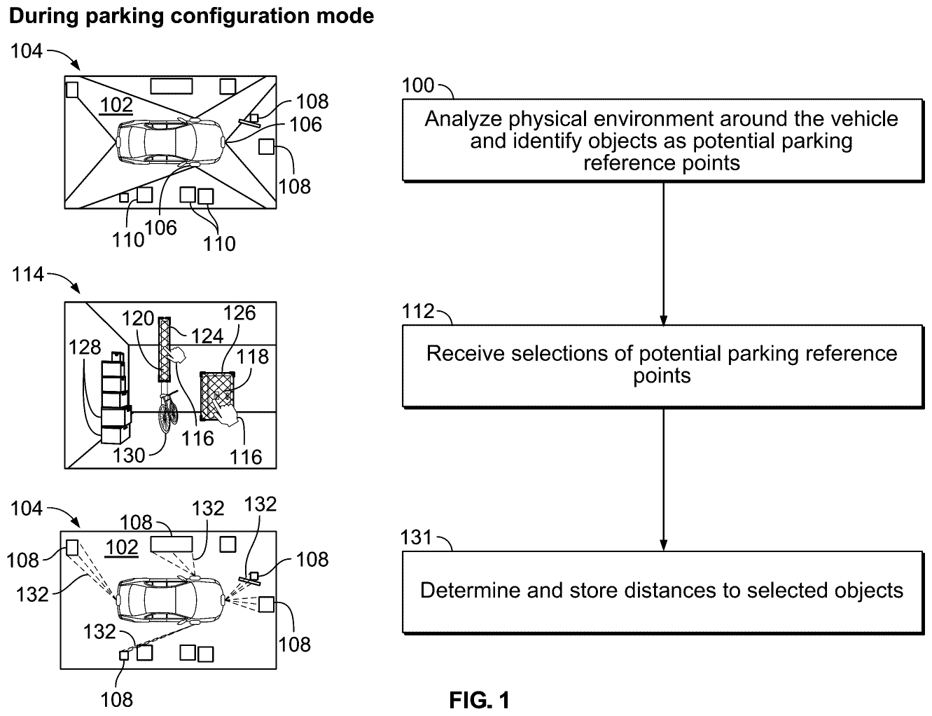

FIG. 1 shows a schematic illustration for determining and storing a specific parking position for a vehicle during parking configuration mode and subsequently guiding the vehicle to the specific parking position during a subsequent parking session, in accordance with some embodiments of this disclosure. In some embodiments, a vehicle, e.g., vehicle 102, may be parked in a crowded or tight parking location such as a home's car garage. Many car garages are used for more than just vehicle parking, serving a dual purpose as storage for objects such as bicycles, tools, workout equipment, home appliances, storage boxes, or any other suitable objects. To ensure that all objects and activities associated with the objects are easily accessible, a specific parking position within the respective crowded parking location may be determined within the parking environment, e.g., parking environment 104. As referred to herein, “the specific parking position” relates to the particular parking position within a crowded parking environment that enables the vehicle to be parked while all activities and items within the crowded parking environment remain practically accessible.

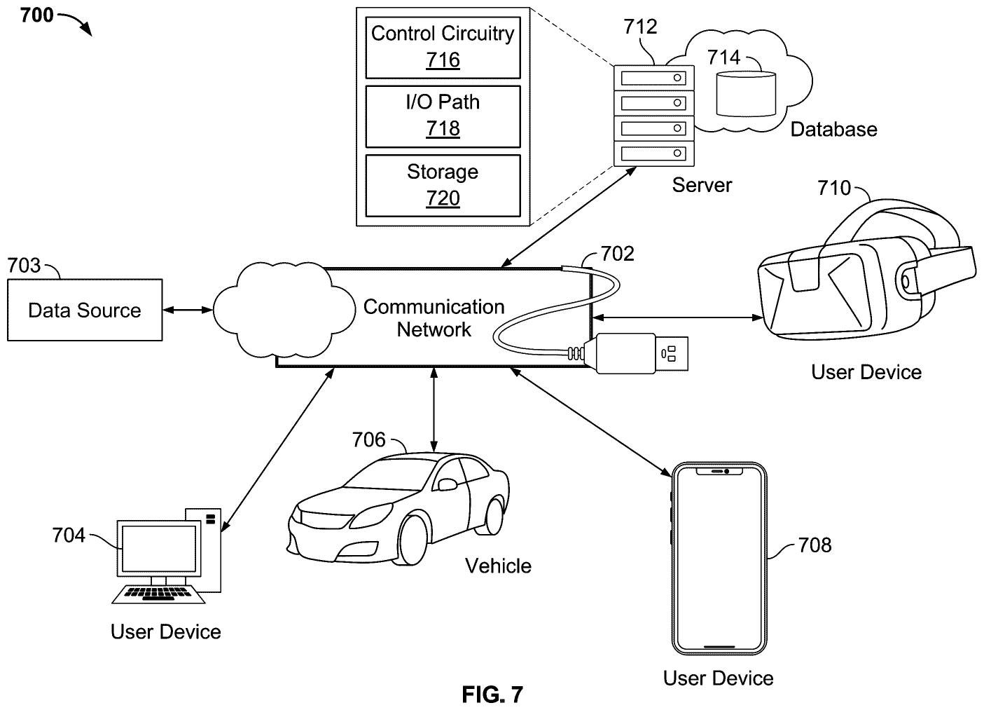

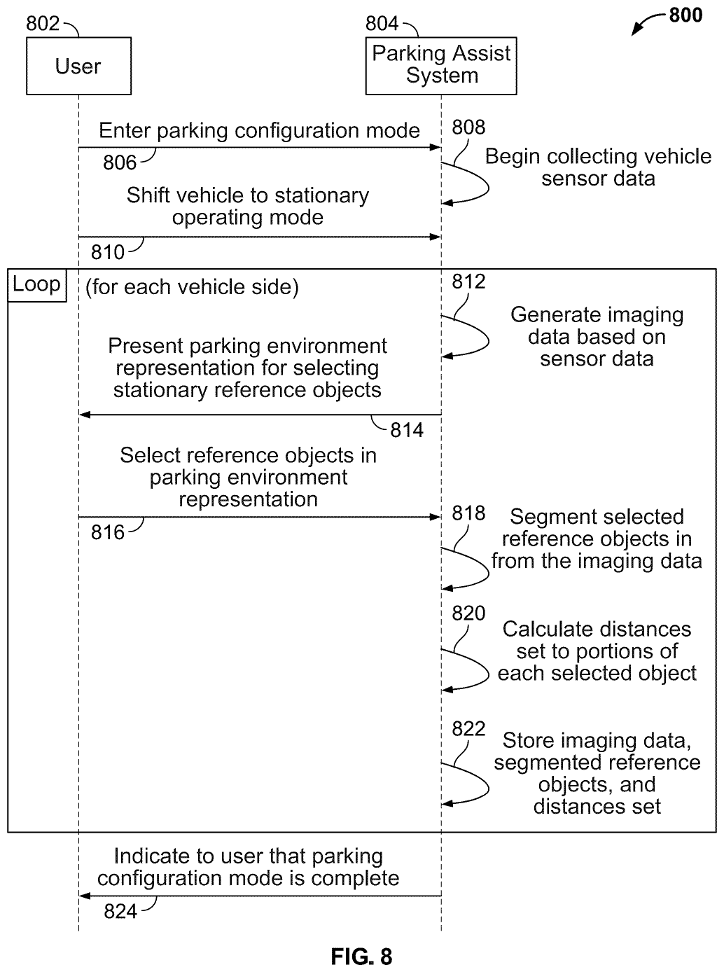

Once vehicle 102 is in the specific parking position, a parking assist application (e.g., running on control circuitry 604 of FIG. 6 and/or control circuitry 716 of FIG. 7) may enter parking configuration mode to analyze and store sensor data (e.g., at storage 606 of FIG. 6 or storage 720 of FIG. 7) of parking environment 104. In some embodiments, the parking configuration mode (e.g., via a user input received from user input interface 616 of FIG. 6) is initiated by receiving user interface input (e.g., via user input interface 616 of FIG. 6) requesting the parking configuration mode. In some embodiments, the parking assist application initiates parking configuration mode based on analyzing the drive setting of the vehicle (e.g., the central processing unit 608 of FIG. 6 determines that the vehicle is set to park and the vehicle motor is turned off).

In some embodiments, the sensor data is data captured by sensors 106 (e.g., corresponding to camera(s) 622 and/or sensor(s) 624 of FIG. 6) of vehicle 102's parking assist system. In some embodiments, sensors 106 may be ultrasonic sensors, radar sensors, LiDAR sensors, camera sensors, or any other suitable measuring equipment to spatially map the surrounding area of the vehicle. The captured sensor data may be depth data, distance data, 3D mapping data, image data or any other type of suitable sensor data. Once the sensor data is captured, control circuitry (e.g., sensor fusion processing unit 612 and/or graphics processing unit 610 of FIG. 6) combines the sensor data to generate a 3D spatial mapping and/or 2D image of vehicle 102's surroundings. The generated spatial mapping and 2D image may be stored (e.g., at storage 606 of FIG. 6 or storage 720 of FIG. 7) to be used as reference data during the parking assist mode in future parking sessions. As referred to herein, “imaging data” refers to data that maps the parking environment via a 3D spatial map, a 2D image, or any other suitable representation of the parking environment.

At step 100, after initiating parking configuration mode, the parking assist application utilizes the imaging data to analyze the physical environment of parking environment 104. Based on the analysis, the parking assist application identifies objects within parking environment 104 as potential parking reference objects for the specific parking position. In some embodiments, identifying objects within parking environment 104 involves using a detection model (e.g., YOLO, R-CNN, or any other suitable detection model). In such embodiments, the parking assist application determines whether a particular object is stationary or movable and dynamically identifies objects that are suitable parking reference objects. For example, the parking assist application may identify stationary objects 108 as potential parking reference objects since, based on the detection model, they correspond to stationary objects such as pillars, wall elements, large home appliances, lighting fixtures, built-in cabinets, or any other suitable stationary object. In contrast, the parking assist application does not identify movable objects 110 as potential parking reference objects, based on the detection model recognizing them to be objects such as tools, sports equipment, storage bins, or any other suitable movable objects. In some embodiments, the parking assist system accesses historical imaging data of parking environment 104 and compares the similarities and differences between the historical imaging data and the current imaging data. If the parking assist application determines that the position of a particular object stays consistent between the historical imaging data and the current imaging data, it designates that particular object as a stationary object. In some embodiments, the parking assist application may not be equipped with a detection model or historical imaging data to automatically determine which objects are stationary. In such embodiments, the parking assist application identifies all analyzed objects (e.g., by segmenting the objects from the imaging data) analyzed objects within parking environment 104 as potential parking reference objects leaving it up to a user to decide which objects to ultimately use as reference objects.

After identifying the potential parking reference objects, at step 112, the parking assist application causes control circuitry (e.g., control circuitry 604 of FIG. 6) to generate (e.g., via graphics processing unit 610 of FIG. 6) at a display (e.g., display 614 of FIG. 6) a parking environment representation 114 to enable a user to select which objects they would like the parking assist system to use as reference objects. In some embodiments, parking environment representation 114 is a camera feed of the parking environment (e.g., received from a camera on the exterior of the vehicle), a digital rendering of the parking environment (e.g., a 3D construction based on spatial mapping data), or any other suitable representation of the parking environment.

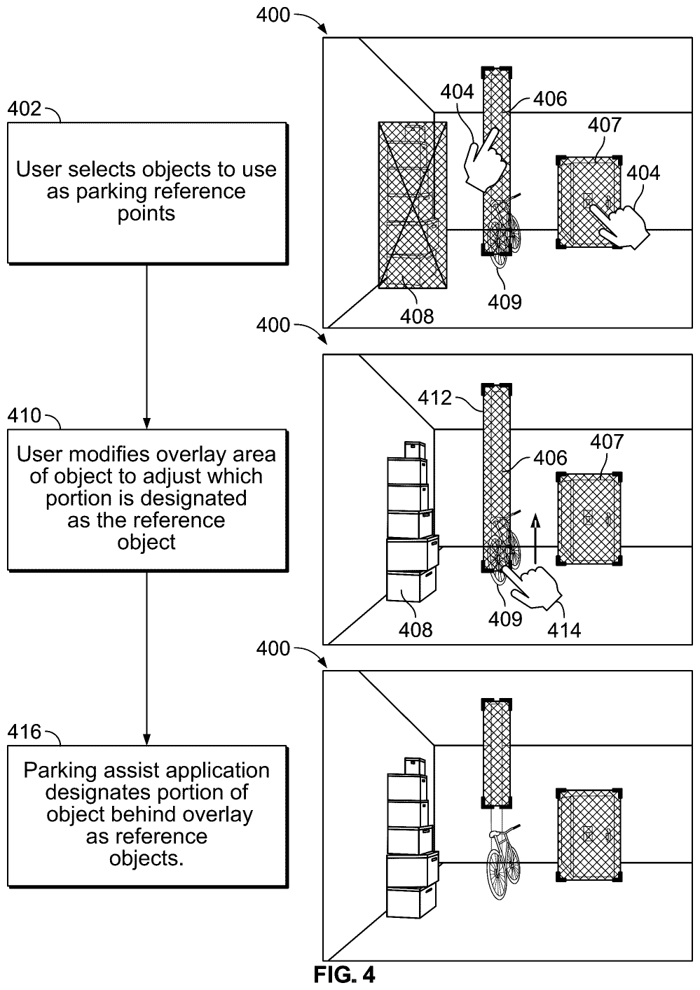

In some embodiments, the parking assist application causes control circuitry to generate overlays (e.g., overlays 124, 126) over potential parking reference objects to discretely show which objects are the best candidates to be reference objects. For example, the control circuitry generates overlays over objects 118, 120 (i.e., a refrigerator and structural pillar) that the detection model identified as stationary, while object 128 (i.e., a stack of boxes) does not have an overlay generated over it since it was identified as movable. In some approaches, the overlay of a respective object represents the portion of the object that will be segmented from the generated imaging data and later used as a reference object. For instance, overlay 124 indicates that only the upper portion of object 120 will be used as a reference object since the bottom portion is obscured by object 130 (i.e., a bicycle). The overlays can also be modified in order to adjust which portions of the object are segmented to be a reference object, as will be discussed further in the description of FIG. 4. In some embodiments, control circuitry does not generate an overlay for a particular object until the parking assist application has received a user selection for the particular object. This may, for example, apply to embodiments where the parking assist application does not have access to detection model data, since without detection model data the parking assist application cannot initially suggest the stationary objects as potential reference objects. When a user input (e.g., user selections 116) corresponding to an object (e.g., objects 118, 120) is received, the parking assist application segments the particular object from the spatial data and moves to step 131 to determine various distances corresponding to the selected object.

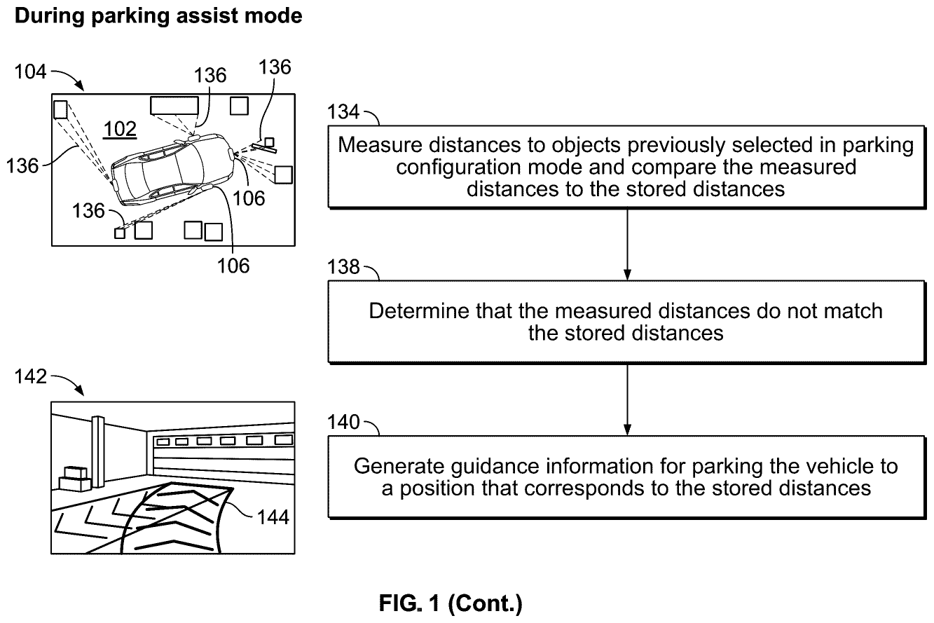

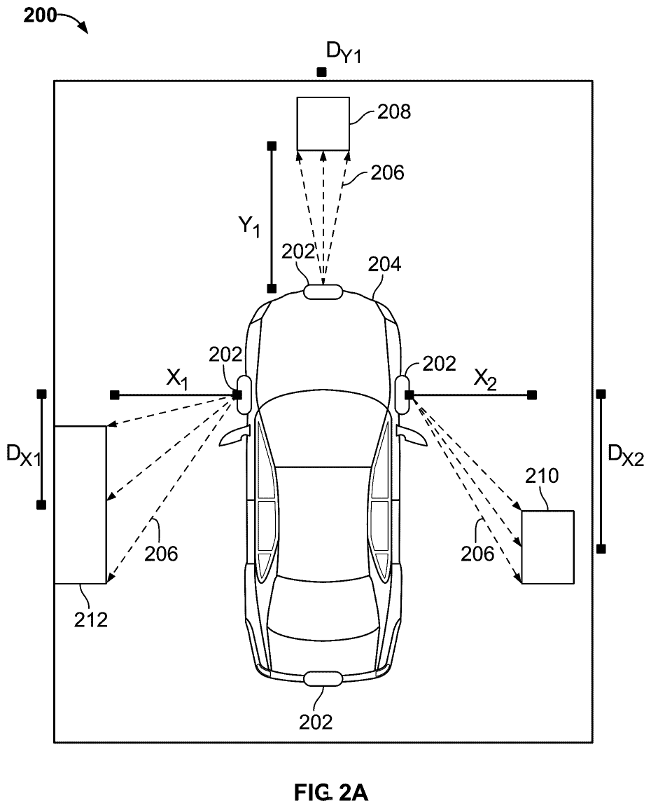

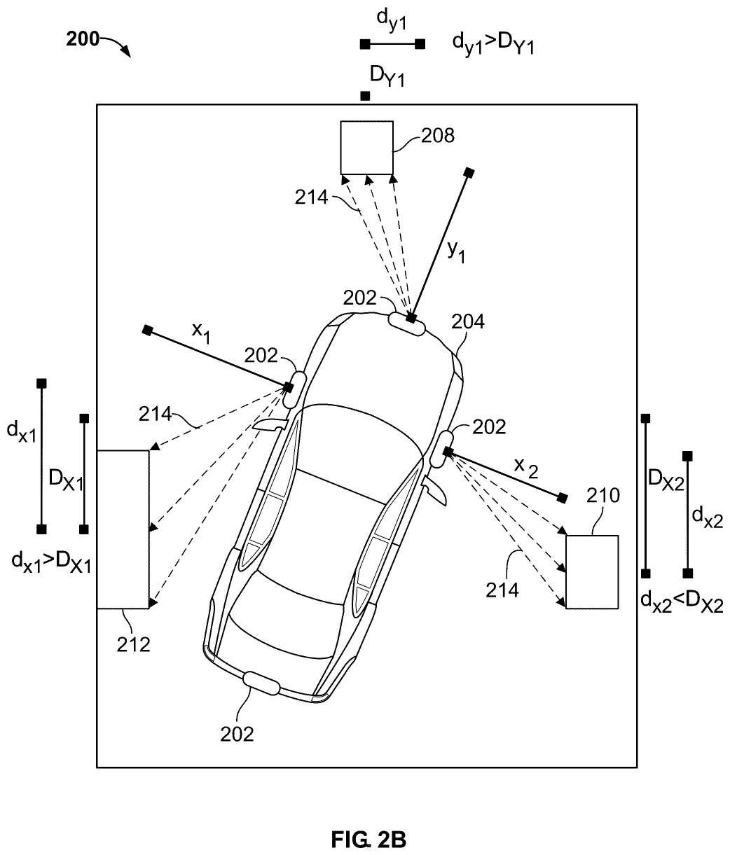

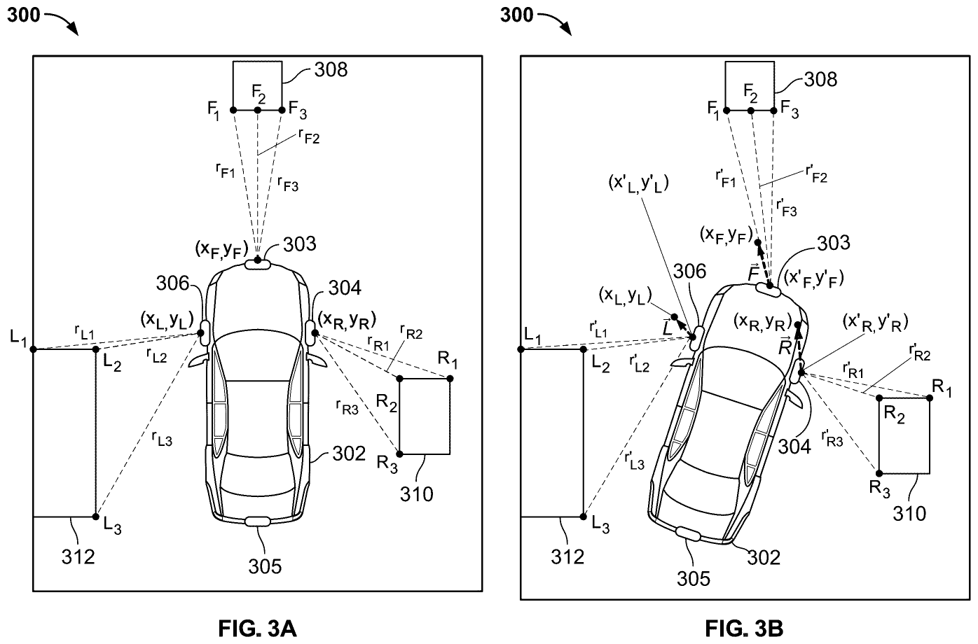

At step 131, the parking assist application determines and stores various distances from vehicle 102 to the objects that have been selected as reference objects. For example, the parking assist application may utilize the sensor data-based imaging data to determine and store distance sets 132 with respect to each of stationary objects 108. As referred to herein a “distance from the vehicle to the reference objects” or any similar phrasing represents a distance between a particular portion of the vehicle and a notable portion of the object being used as a reference object. In some embodiments, the particular portion of the vehicle may be the location of a vehicle sensor, a vehicle surface point, an origin point of the vehicle's imaging data coordinate system or any other suitable portion of the vehicle to measure distance from. In some embodiments, the notable portions of the object are edges, corners, landmarks (e.g., unique or high-contrast points of the object), surface centers, or any other suitable portions of the object to accurately measure distance from. After completing step 131, the parking assist system can determine and store the alignment of vehicle 102 in the current specific parking position as a function of stored distance sets 132. The possible embodiments by which distance sets are measured and stored are further discussed in the descriptions of FIGS. 2A-2B, and FIGS. 3A-3B.

During a subsequent parking session, the parking assist application initiates (e.g., via control circuitry) parking assist mode to provide precise guidance for aligning vehicle 102 into the specific parking position vehicle 102 was in during parking configuration mode. In some embodiments, the control circuitry (e.g., control circuitry 604) automatically initiates (e.g., via central processing unit 608 of FIG. 6) parking assist mode based on recognizing that vehicle 102 has entered parking environment 104, e.g., by determining the vehicle GPS location is a threshold distance from the stored GPS location of parking environment 104 and/or by detecting similarities between the current imaging data of the vehicle's environment to a stored historical imaging data of parking environment 104. In some embodiments, control circuitry initiates parking assist mode in response to receiving a user input (e.g., received via user input interface 616 of FIG. 6).

At step 134, sensors 106 measure distances from vehicle 102 to the previously selected reference objects in parking environment 104 to generate distance sets 136 for each object. The parking assist application may then, for each object, compare the corresponding distance sets 136 and stored distance sets 132 to determine where vehicle 102 is within parking environment 104 and how far away the vehicle 102′s current parking position is from the specific parking position. At step 138, the parking assist application determines that one or more of the distance sets 136 do not match stored distance sets 132 for one or more corresponding reference objects, therefore indicating that the vehicle is not currently aligned in the specific parking position.

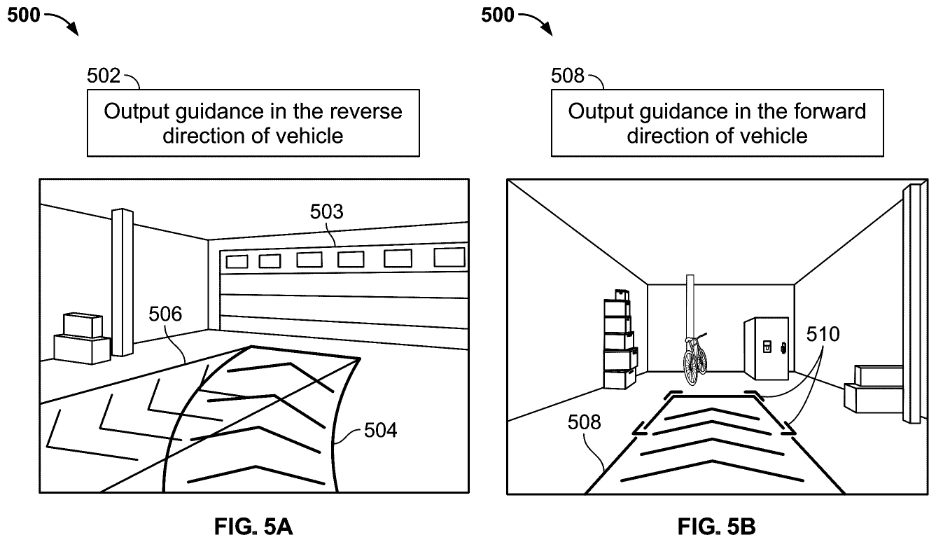

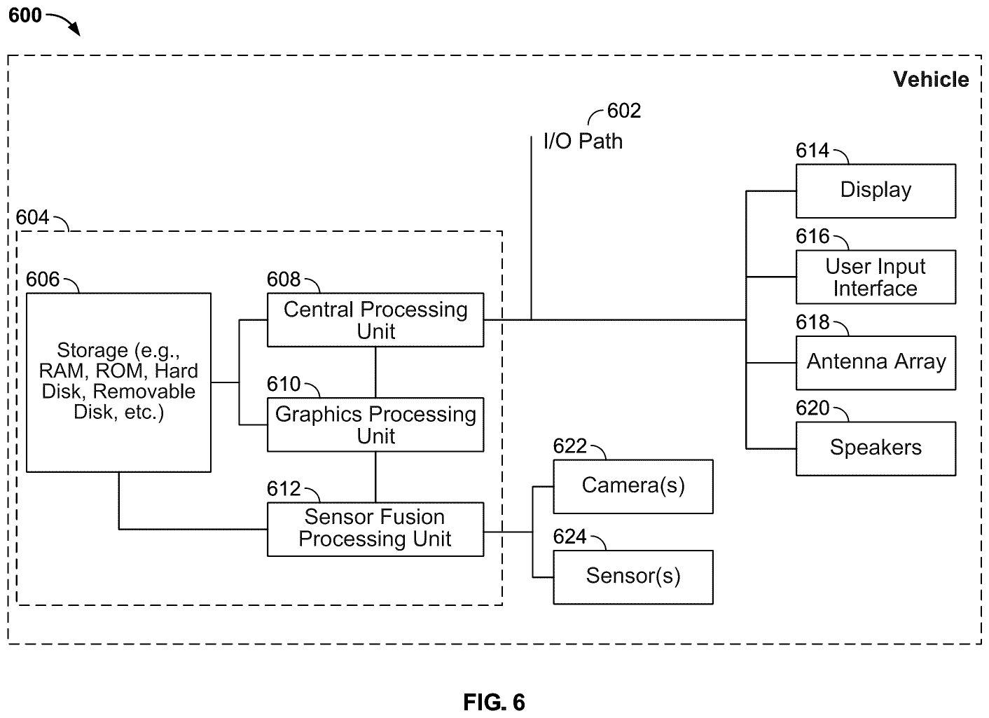

At step 140, the parking assist application generates parking guidance information based on the comparison between distance sets 136 and stored distance sets 132. The goal for the parking assist application is to provide driving guidance that allows a user to align their vehicle in a position that precisely matches the specific parking position associated with the stored distance sets 132. The parking assist application may therefore employ a path-planning algorithm that leverages the imaging data of the parking environment 104, distance sets 136 and stored distance sets 132 to calculate parking guidance information. In some embodiments, the path-planning algorithm is a Hybrid A algorithm, Dijkstra algorithm, potential field algorithm, machine learning algorithm, or any other suitable path-planning algorithm. In some embodiments, after the path-planning algorithm calculates the parking guidance information, the parking assist application causes the control circuitry to generate (e.g., via graphics processing unit 610 of FIG. 6) at a display (e.g., display 614 of FIG. 6) a parking environment representation 142 that visualizes the parking guidance information, e.g., in the form of optimal trajectory overlay 144. In some embodiments, the parking guidance information is provided in the form of audio cues. By following the parking guidance information provided by the parking assist application, the driver can precisely park the vehicle in the specific parking location without being required to perform any readjustments, and/or clearance checks. The embodiment of generating for display an optimal trajectory overlay is discussed further in the descriptions of FIGS. 5A-5B. In some embodiments, the vehicle is also equipped with an autonomous driving system, in which case the parking assist application transmits the parking guidance information to the autonomous driving system to automatically park the vehicle into the specific parking position. The initial parking configuration mode and the subsequent uses of parking assist mode therefore enable efficient parking guidance to align a vehicle in the specific parking position while also assuring that any activity or item is accessible within the parking environment while the vehicle is parked.

FIGS. 2A-2B show schematic illustrations for determining the normal distance and offset distance between a vehicle and a reference object during parking configuration mode and subsequently utilizing the determined distances during parking assist mode, in accordance with some embodiments of this disclosure. In some embodiments, the parking assist application measures and stores a set of distances for each reference object (e.g., stationary objects 108 of FIG. 1) during parking configuration mode. As discussed further below, the parking assist application then compares the stored distance sets (e.g., distance sets 134 of FIG. 1) to distance sets measured during future parking sessions to generate parking guidance for the vehicle. In some embodiments, the distance sets measured and stored during parking configuration mode correspond to, for each reference object, a normal distance, and an offset distance between a particular portion of the vehicle (e.g., the location of a vehicle sensor) and a notable portion of the reference object (e.g., the center of the reference object). For example, as shown in parking environment 200, sensors 202 (e.g., corresponding to camera(s) 622 and/or sensor(s) 624 of FIG. 6) of vehicle 204 initially measure distances 206 between vehicle 204 and various portions of reference objects 208, 210, 212. In some embodiments, the parking environment does not contain a stationary reference object for all sides of the vehicle. For example, parking environment 200 does not contain a reference object for measuring distance from the rear of the vehicle. In such embodiments, the data from sensors that do not face a reference object are not utilized in measuring distances 206.

In some embodiments, distances 206 are measured by leveraging mapping techniques based on 3D data such as LiDAR-based mapping, radar-based mapping, simultaneous localization and mapping (SLAM), or any other suitable 3D data-based mapping technique. Such techniques may be applied if the vehicle is equipped with sensors such as LiDAR, radar, sonar, or any other suitable spatial sensor. Each of the listed techniques enables control circuitry (e.g., control circuitry 604 of FIG. 6) to generate point clouds, a 3D mesh, or any other suitable 3D representation of the parking environment (e.g., using sensor fusion processing unit 612 and/or graphics processing unit 610 of FIG. 6). In such embodiments, each of these 3D representations provides a precise model of the parking environment. Thus, when leveraged by the parking assist application, a 3D representation enables an accurate measurement of distances 206.

In some embodiments, distances 206 are measured by leveraging mapping techniques based on 2D data such as stereo vision, monocular depth estimation, photogrammetry, or any other 2D-data-based mapping technique. Such techniques may be applied if the vehicle is equipped with multiple cameras whose images can be combined to estimate a 3D model of the parking environment. In such embodiments, the 3D model estimation can provide an accurate estimation of the parking environment and is therefore also effective in accurately measuring distances 206.

In some embodiments, after measuring distances 206, control circuitry executes an additional geometric calculation (e.g., triangulation) based on distances 206 to determine a distance set including a normal distance and an offset distance for each of the reference objects with respect to a particular portion of the vehicle. For example, control circuitry determines distance set (X₁, D_{X1}) for reference object 212, distance set (X₂, D_{X2}) for reference object 210, and distance set (Y₁, D_{Y1}) for reference object 208. Each normal distance (i.e., X₁, X₂, Y₁) corresponds to a distance between one of sensors 202 and a portion of the reference object such that the distance is perpendicular to the sensor surface. Each offset distance (i.e., D_{X1}, D_{X2}, D_{Y1}) corresponds to the orthogonal distance between one of the sensors 202 and a portion of the reference object (e.g., the center of the object surface facing the vehicle). Orthogonal distance refers to the distance between a first measuring point and the projection of second measuring point projected onto an axis (e.g., the surface of the vehicle) on which the first measuring point resides. Once control circuitry determines a normal distance and offset distance for each reference object during parking configuration mode, the parking assist application causes the control circuitry to store the data (e.g., at storage 606 of FIG. 6 or storage 720 of FIG. 7) so that the data can be used to provide parking guidance information while in parking assist mode.

FIG. 2B shows a schematic illustration for utilizing the distances determined during configuration mode to compare them to distances determined during parking assist mode, in accordance with some embodiments of this disclosure. FIG. 2B illustrates parking environment 200 when vehicle 204 is not aligned in the specific parking position. In some embodiments, the parking assist application initiates parking assist mode to provide parking guidance information for maneuvering the vehicle from its current position to the specific parking position. In some embodiments, the parking assist application initiates (e.g., via central processing unit 608 of FIG. 6) parking assist mode based on recognizing that the vehicle has entered parking environment 200, e.g., by using GPS data, comparing current imaging data to stored historical imaging data of the vehicle surroundings, any other suitable detection method, or any combination thereof. In some embodiments, the parking assist application initiates parking assist mode in response to receiving a user input.

While in parking assist mode, the parking assist application analyzes the vehicle's surroundings to identify all objects in parking environment 200 that were designated as reference objects during parking configuration mode, e.g., reference objects 208, 210, 212. In some embodiments, the parking assist application leverages current imaging data, stored imaging data generated during parking configuration mode, a detection model, and any other necessary data and/or techniques to identify the reference objects within parking environment 200.

With the reference objects identified, sensors 202 (e.g., corresponding to camera(s) 622 and/or sensor(s) 624 of FIG. 6) of vehicle 204 measure distances 214 between vehicle 204 and various portions of reference objects 208, 210, 212. Since vehicle 204 is not aligned into the specific parking position during parking assist mode as it was during parking configuration mode, distances 214 differ from distances 206 previously measured during parking assist mode. Thus, when control circuitry utilizes distances 214 to execute the same geometric calculations as were performed during parking configuration mode, the resulting calculations yield a different set of a normal distance and an offset distance for at least one of the reference objects with respect to a particular portion of the vehicle. For example, control circuitry (e.g., sensor fusion processing unit 612 and/or graphics processing unit 610 of FIG. 6) yields distance set (x₁, dₓ₁) for reference object 212, distance set (x₂, dₓ₂) for reference object 210, and distance set (y₁, d_{y1}) for reference object 208.

In some embodiments, the parking assist application retrieves the distance sets stored during parking configuration mode and compares, for each reference object, the stored distance set to the distance set measured during parking assist mode. For example, the parking assist application may compare stored and current offsets and determine that dxi is greater than D_{X1}, dₓ₂ is less than D_{X2}, and d_{y1} is greater than D_{Y1}. The combination of these facts enables the parking assist application to determine that the vehicle is rotated too far to the right within the parking environment. Based on the determination of the vehicle's misalignment with respect to the stored distance sets, the parking assist application subsequently generates parking assist guidance information that demonstrates which vehicle maneuvers will cause the measured distance sets and stored distance sets to match (or be within a threshold similarity). When the measured distance sets and stored distance sets match (or are within a threshold similarity), the vehicle is aligned in the specific parking position set during parking configuration mode.

While the example depicted by FIGS. 2A-2B demonstrates the parking assist application determining the vehicle alignment within a parking environment based on three reference objects, the parking assist application may rely on any number of reference objects. For example, the parking assist application may rely on just one reference object (e.g., due to vehicle imaging limitations and lack of available reference objects) to determine vehicle position. However, for calculations based on a single reference object, the parking assist application may experience reduced accuracy in determining the vehicle's exact position.

FIGS. 3A-3B show schematic illustrations for determining distances between a vehicle and notable portions of a reference object during parking configuration mode and subsequently utilizing the determined distances during parking assist mode to determine vehicle alignment, in accordance with some embodiments of this disclosure. FIG. 3A, in particular, demonstrates how the parking assist application leverages a representation (e.g., a camera feed, or a 3D representation, or any other suitable representation) of the parking environment during parking configuration mode to calculate a specific parking position of the vehicle with respect to certain reference objects. FIG. 3A depicts vehicle 302 positioned within parking environment 300, which includes reference objects 308, 310, 312. When parking configuration mode is initiated, the parking assist application causes control circuitry (e.g., control circuitry 604 of FIG. 6) to generate imaging data (e.g., a 3D spatial map, a 2D image, or any other suitable representation of the parking environment) of parking environment 300 (e.g., using sensor fusion processing unit 612 and/or graphics processing unit 610 of FIG. 6).

In some embodiments, the parking assist application uses a representation of parking environment 300 to pinpoint the locations of notable portions of each reference object and measure the distance from each notable portion to a particular part of the vehicle. In some embodiments, the notable portions of the object are edges, corners, landmarks (e.g., unique or high-contrast points of the object), surface centers, or any other suitable portions of the object to accurately measure distance from. For example, the parking assist application determines the set of locations (L₁, L₂, L₃) for object 312 and (R₁, R₂, R₃) for object 310, which corresponds to the three visible corners of each object in the 3D representation of parking environment 300. The parking assist application determines location set (F₁, F₂, F₃) for object 308, which corresponds to the two visible edges and the center of the visible surface of the object. In some embodiments, each location of each notable object portion is the coordinates of the respective object portion with respect to a particular portion of the vehicle as the origin point. In some embodiments, the particular portion of the vehicle may be the location of a vehicle sensor, a vehicle surface point, an origin point of the vehicle's imaging data coordinate system or any other suitable portion of the vehicle to measure distance from.

In some embodiments, while in parking configuration mode, the parking assist application employs geometric techniques on the determined locations set of each reference object to determine a specific position of the vehicle with respect to the reference object. For example, the parking assist application may leverage the locations set of a reference object and the respective distances to the vehicle (i.e., (r_{L1}, r_{L2}, r_{L3}) corresponding to (L₁, L₂, L₃), (r_{R1}, r_{R2}, r_{R3}) corresponding to (R₁, R₂, R₃), (r_{F1}, r_{F2}, r_{F3}) corresponding to (F₁, F₂, F₃)) to perform a trilateration calculation with respect to each reference object. These calculations determine the coordinates of portions (e.g., the position of the sensors) of the vehicle with respect to a particular reference object. For example, the calculations place sensor 306 at (x_{L}, y_{L}) with respect to reference object 312, sensor 303 at (x_{F}, y_{F}) with respect to object 308, and sensor 304 at (x_{R}, y_{R}) with respect to reference object 310, when the vehicle is in its specific parking position. The parking assist application records these sensor coordinates (e.g., in storage 606 of FIG. 6 or storage 720 of FIG. 7) to establish the vehicle's alignment within parking environment 300 in the specific parking position. In some embodiments, not every sensor faces a reference object. For example, sensor 305 faces the back parking environment 300 that does not contain a reference object. In such embodiments, sensors that do not face a reference object are not utilized in determining distances and positions with respect to reference objects.

FIG. 3B shows a schematic illustration for utilizing the distances determined during configuration mode to compare them to distances determined during parking assist mode, in accordance with some embodiments of this disclosure. FIG. 3B illustrates parking environment 200 when vehicle 204 is not aligned in the specific parking position. In some embodiments, after initiating parking assist mode, the parking assist application performs the same trilateration technique as described above to determine the current alignment of the vehicle with respect to the known reference objects within parking environment 200. For example, using trilateration, the parking assist application now places sensor 306 at (x′_{L}, y′_{L}) with respect to reference object 312, sensor 303 at (x′_{F}, y′_{F}) with respect to object 308, and sensor 304 at (x′_{R}, y′_{R}) with respect to reference object 310. By retrieving the stored sensor coordinates and calculating the difference to the current sensor coordinates, the parking assist application can precisely calculate the vehicle's misalignment from the specific parking position. For example, the parking assist application calculates misalignment vector, \vec{L} (i.e., the vector between coordinates (x_{L}, y_{L}) and (x′_{L}, y′_{L})) for sensor 306; misalignment vector, \vec{F} (i.e., the vector between coordinates (x_{F}, y_{F}) and (x′_{F}, y′_{F})) for sensor 303; and misalignment vector \vec{R} (i.e., the vector between coordinates (x_{R}, y_{R}) and (x′_{R}, y′_{R})) for sensor 304, providing a clear vectorial representation of how each sensor location deviates from its stored coordinates.

In some embodiments, the parking assist application may then feed the calculated data (e.g., including the reference object positions, stored and newly calculated sensor coordinates, imaging data of the current state of parking environment 300, the misalignment vectors and any other necessary data) to a path-planning algorithm that determines how to minimize the misalignment vectors to 0 from the vehicle's current position. In some embodiments, the path-planning algorithm is a Hybrid A algorithm, Dijkstra algorithm, potential field algorithm, machine learning algorithm, or any other suitable path-planning algorithm. The path calculated by the path-planning algorithm may then be presented as parking guidance information (e.g., via a parking guidance overlays 506, 508 of FIG. 5).

FIG. 4 shows a schematic illustration for displaying a representation of a parking environment and receiving user selections of objects via a user interface, in accordance with some embodiments of this disclosure. When a vehicle enters parking configuration mode, the parking assist application causes display of parking environment representation 400. In some embodiments, the parking assist application causes display of parking environment representation 400 on the display of the vehicle (e.g., display 614 of FIG. 6), the display of a mobile device, a personal computer, an extended-reality headset, or any other suitable display. In some embodiments, parking environment representation 400 is a camera feed of the parking environment (e.g., receive from a camera on the exterior of the vehicle), a digital rendering of the parking environment (e.g., a 3D construction based on spatial mapping data), or any other suitable representation of the parking environment. In some embodiments, parking environment 400 may only depict one perspective of the parking environment. In such embodiments, the user interface (e.g., user input interface 616 of FIG. 6) may include selectable options to switch to a different parking environment representation for a different perspective of the parking environment. In some embodiments, parking configuration mode and the subsequent display of parking environment representation 400 is caused by the parking assist application determining that the vehicle is in a particular drive setting (e.g., the central processing unit 608 of FIG. 6 determines that the vehicle is set to park and the vehicle motor is turned off).

In some embodiments, the parking assist application causes control circuitry (e.g., control circuitry 604 of FIG. 6) to generate (e.g., via graphics processing unit 610 of FIG. 6) an overlay over each object depicted in parking environment representation 400 to either encourage (e.g., overlays with crop indicators, with highlights, with a special animation, or any other suitable overlay) or discourage (e.g., overlays with an X, overlays that cause the object to fade, reduce in pixel quality/intensity, become a silhouette, or any other suitable overlay) a user from selecting a particular object. The parking assist application may determine whether to encourage or discourage selection of an object based on detection model data (e.g., data from YOLO, R-CNN, or any other suitable detection model) that indicates which objects are stationary and which objects are movable. In some embodiments, the detection model data indicates a portion of a stationary object that is obstructed by a movable object (e.g., a bicycle). In such embodiments, the parking assist application automatically modifies the overlay of the respective stationary object to cover only the unobstructed portion. In some embodiments, the parking assist application does not have access to detection model data, in which case the parking assist application does not generate overlays over objects until after receiving user selections for the respective objects.

In some embodiments, while parking environment representation 400 is displayed, the parking assist application receives, at step 402, user selections of objects depicted within parking environment representation 400. For example, the parking assist application receives user selections 404 (e.g., via user input interface 616 of FIG. 6) for stationary objects 406, 407 (e.g., a structural pillar and a refrigerator). The user selections for respective objects provide an instruction to the parking assist application to use the respective objects as reference objects. As shown in parking environment representation 400, stationary object 406 (i.e., the structural pillar) is obstructed by movable object 409 (i.e., a bicycle). In embodiments where a user selects an obstructed stationary object such as the structural pillar obstructed by a bicycle, the parking assist application may provide a warning and/or directive to not select the respective stationary object (e.g., via a popup window or audio cue). In some embodiments, the parking assist application may present a request to a user to relocate movable objects such that they do not obstruct a stationary object.

In some embodiments, the overlays of each selected object represent the portion of the stationary object that will be segmented from the generated imaging data and used as a reference object. In some embodiments, overlays of selected objects can be modified, e.g., to prevent the overlay from covering a movable object. For example, at step 410, the parking assist application modifies overlay 412 to cover only the unobstructed portion of stationary object 406 based on user input 414 received via a user interface (e.g., via user input interface 616 of FIG. 6). In some embodiments, the parking assist application automatically modifies an overlay to cover only the unobstructed portion of a stationary object based on detection model data (e.g., the detection model data determines that the top of stationary object 406 is uncovered). In some embodiments, automatic and/or manual modification of an object overlay is performed in response to the parking assist application transmitting a request to modify a respective overlay so as not to cover a movable object. In some approaches, the parking assist application does not move to the next step of parking configuration mode until it confirms that all overlays of selected objects cover only stationary objects.

In some embodiments, the parking assist application may provide a suggestion to add a fiducial marker (e.g., a high contrast color sticker or shape) to an otherwise unremarkable area within view, such as a wall, to create a reference object or make portions of a reference object easier to detect/measure (such an embodiment is especially relevant to vehicles that employ photo image sensors). For example, the parking assist application may suggest installing a sticker along the flat surface of a rectangular pillar (e.g., stationary object 406) to enable the parking assist application to determine distance along the pillar more accurately.

At step 416 the parking assist application designates the object portions covered by overlays as the selected objects. The parking assist application then stores distances and location coordinates (e.g., such as those described in FIGS. 2A-2B and FIGS. 3A-3B) between various points of each reference object and the vehicle, as well as a spatial map of parking environment 400. This information is saved in memory (e.g., storage 606 in FIG. 6 or storage 720 in FIG. 7) for use during parking assist mode in later parking sessions.

FIGS. 5A-5B show an illustrative example for displaying parking guidance information during parking assist mode, in accordance with some embodiments of this disclosure. In some embodiments, based on determining during parking assist mode that the vehicle is not aligned into the specific parking position (e.g., based on comparing distance sets as described in FIGS. 2A-2B and/or coordinates as described in FIGS. 3A-3B), the parking assist application generates parking guidance information. In some embodiments, the parking assist application generates the parking guidance information by leveraging a path-planning algorithm (e.g., Hybrid A algorithm, Dijkstra algorithm, potential field algorithm, machine learning algorithm, or any other suitable path-planning algorithm) that outputs a feasible path to maneuver the vehicle into the specific parking position. In some approaches, the feasible path can be customized to be the easiest path, the most time efficient, the most fuel efficient, or any other path type to the specific parking position.

In some embodiments, the parking guidance information is presented as visual cues (e.g., via a vehicle display, an augmented-reality head-up display, a mobile device, or any other suitable display device), as audio cues (e.g., beeps, voice instructions, or any other suitable audio cue), or any other suitable form of parking guidance information. FIGS. 5A-5B, in particular, depict an example scenario in which the parking guidance information is displayed as visual cues overlayed over a representation (e.g., a camera feed, or a 3D representation, or any other suitable representation) of parking environment 500. As indicated by parking guidance overlays 504, 506, the vehicle is currently translationally and rotationally misaligned with respect to the specific parking position (i.e., the vehicle is positioned and angled too far to the left). By determining the vehicle misalignment with respect to known reference objects (e.g., using techniques described in FIGS. 2A-2B and/or FIGS. 3A-3B), the parking assist application generates for display the parking guidance information in the form of suggested trajectories. For example, since the vehicle must resolve an angular misalignment, the parking assist application performs step 502 and causes for display a rear-view perspective of parking environment 500 with parking guidance overlay 504 overlayed to demonstrate how the vehicle should be maneuvered. In some embodiments, the parking assist application will also generate for display visual cues corresponding to an upcoming suggested vehicle maneuver. For example, the parking assist application displays parking guidance overlay 506 corresponding to an upcoming suggested forward trajectory from the rear-view perspective of parking environment 500. In some embodiments, once the vehicle has completed the maneuver corresponding to parking guidance overlay 504, the parking assist application provides an indication (e.g., via a visual cue, haptic cue, audio cue) that the suggested trajectory has been successfully followed.

In some embodiments, the parking assist application must provide multiple suggested trajectories to get the vehicle to the specific parking position. For example, after providing guidance for reversing the vehicle into angular alignment within parking environment 500, the parking assist application subsequently causes for display a front-view perspective of parking environment 500 with parking guidance overlay 506 at step 502. Parking guidance overlay 506 provides a suggested trajectory that finishes precisely at the specific parking spot that was configured during parking configuration mode. In some embodiments, the final guidance overlay (i.e., parking guidance overlay 506) of the parking guidance information will include an indication of where the specific parking position is within parking environment. For example, parking guidance overlay 506 includes parking spot indicators 510 to indicate the position of the specific parking position. In some embodiments, once the vehicle has aligned itself to the specific parking position, the parking assist application provides an indication (e.g., via a visual cue, haptic cue, audio cue) that the parking process is complete. FIGS. 5A-5B demonstrate how the process of displaying parking guidance information (e.g., via guidance overlays) enables the parking assist application to provide a precise method for consistently parking a vehicle in a specific parking position. Users of the parking assist application thus are able to efficiently park their vehicle while being assured that they do not need to provide any subjective input of their own.

In some embodiments, the parking assist application is implemented on an autonomous vehicle. In such embodiments, the autonomous driving system of the vehicle may automatically maneuver the vehicle into the specific parking position based on the parking guidance information provided by the parking assist application. In such embodiments, the parking assist application may still display a representation of the parking environment along with the guidance overlays to provide a user insight on where the vehicle is moving to.

In some approaches, the parking assist application may provide options on which type of alignment (e.g., translational, angular, or both) needs to be achieved in order to determine a successful parking job during parking assist mode. For example, the parking assist application may be configured to provide an indication of a successful parking job only when the vehicle is angularly aligned in the specific parking position.

In some embodiments, an obstruction (e.g., an object in the path of the suggested parking trajectory) that was not present during parking configuration mode may be detected in the parking environment during a subsequent use of parking assist mode. In such embodiments, the parking assist system may send an indication (e.g., via an alert presented on display 614 of FIG. 6) regarding the detected obstruction. In some approaches, the indication is a message from the parking assist application that the specific parking position is unattainable in the current state of the parking environment; a specialized overlay presented over the object in the displayed representation of the parking environment; a request to move the obstruction to a different position within the parking environment; or a combination of any of the mentioned indications.

In some embodiments, the obstruction that was not present during parking configuration mode obstructs a portion of a reference object. In some approaches, the parking assist application sends a request to a user to move the obstruction away from the reference object. In some approaches, the parking assist application modifies the stored distance sets (e.g., distance sets of FIGS. 2A-2B and/or distance sets of FIGS. 3A-3B) and imaging data to correspond to the portion of the reference object that is still unobstructed. In such approaches, the parking assist application then uses the modified data for the respective reference object to determine whether the vehicle is aligned in the specific parking position with respect to the obstructed reference object (i.e., the parking assist application can provide parking guidance information even if portions of reference objects are obstructed).

As shown in FIG. 5A, the parking environment may sometimes include a garage door (e.g., garage door 503) or gate. In some embodiments, the parking assist application simultaneously causes the garage door to open and initiates parking assist mode based on determining the vehicle GPS location is a threshold distance from the stored GPS location of the parking environment and/or by detecting similarities between the current imaging data of the vehicle's environment to stored historical imaging data of the parking environment. Such embodiments ensure that the parking assist application provides quick access to the parking environment and immediate generation of parking guidance information without the need for any user input.

In some embodiments, a parking environment is a multi-vehicle garage with multiple corresponding garage doors. In such embodiments, the data for a specific parking position for a vehicle is associated with the garage door of the parking environment from which the specific parking position is accessible. Thus, when the parking assist application determines that the vehicle is near the parking environment (e.g., based on the vehicle's GPS location or imaging data of the vehicle environment), the parking assist application opens only the garage door from which the specific parking garage is accessible. Conversely, a second garage door may be associated with data for a specific parking position of a different second vehicle. Thus, when the parking assist application of the second vehicle determines that the vehicle is near the parking environment, it opens only the second garage door. Such embodiments can help mitigate energy consumption in a parking environment by opening only the necessary access points to the parking environment when parking a vehicle with parking assist mode.

FIG. 6 is a block diagram of an illustrative example of vehicle architecture 600, in accordance with embodiments of the disclosure. More specific implementations of user equipment devices are discussed above and below in connection with FIG. 6. Vehicle architecture 600 may send and receive data via input/output (I/O) path 602. I/O path 602 may provide data to control circuitry 604, central processing unit (CPU) 608, graphics processing unit (GPU) 610, sensor fusion processing unit (SFPU) 612, and storage 606. In some embodiments I/O path 602 is an input/output circuitry. Control circuitry 604 may be used to send and receive commands, requests, and other suitable data using I/O path 602. For example, control circuitry may use I/O path 602 to send requests to store and/or retrieve distance sets and imaging data stored during parking configuration mode.

Control circuitry 604 may be based on any suitable processing circuitry such as CPU 608, GPU 610, and SFPU 612. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units (e.g., CPU 608, GPU 610, and SFPU 612). The demonstrated processing units of control circuitry 604 are an exemplary layout for a user equipment that can achieve the tasks of the disclosed invention. Any suitable embodiment, of control circuitry configurations and components may be used. In some embodiments control circuitry 604 executes instructions for a parking assist application stored in memory (i.e., storage 606). Specifically, control circuitry 604 may be instructed by the parking assist application to perform the functions discussed above and below. For example, the parking assist application may provide instructions to control circuitry 604 to generate imaging data of the vehicle's parking environment based on data received from camera(s) 622 and sensor(s) 624. In some implementations, any action performed by control circuitry 604 may be based on instructions received from the parking assist application.

In client/server-based embodiments, control circuitry 604 may include communications circuitry suitable for communicating with networks or servers (e.g., server 712 of FIG. 7). The instructions for carrying out the above-mentioned functionality may be stored on a server. Communications circuitry may include an Ethernet card or a wireless modem for communications with other equipment, or any other suitable communications circuitry. Such communications may involve the internet or any other suitable communication network or paths (which are described in more detail in connection with FIG. 7). In addition, communications circuitry may include circuitry that enables peer-to-peer communication of user equipment devices (described in more detail in description of FIG. 7), or communication of user equipment devices in locations remote from each other.

In some embodiments, an antenna array 618 is provided in the vehicle architecture 600. Antenna array 618 may comprise one or more of AM/FM radio antennas, satellite radio antennas, GPS antennas, Wi-Fi or cellular antennas, radar/sensor antennas, keyless entry antennas, or Bluetooth antennas.

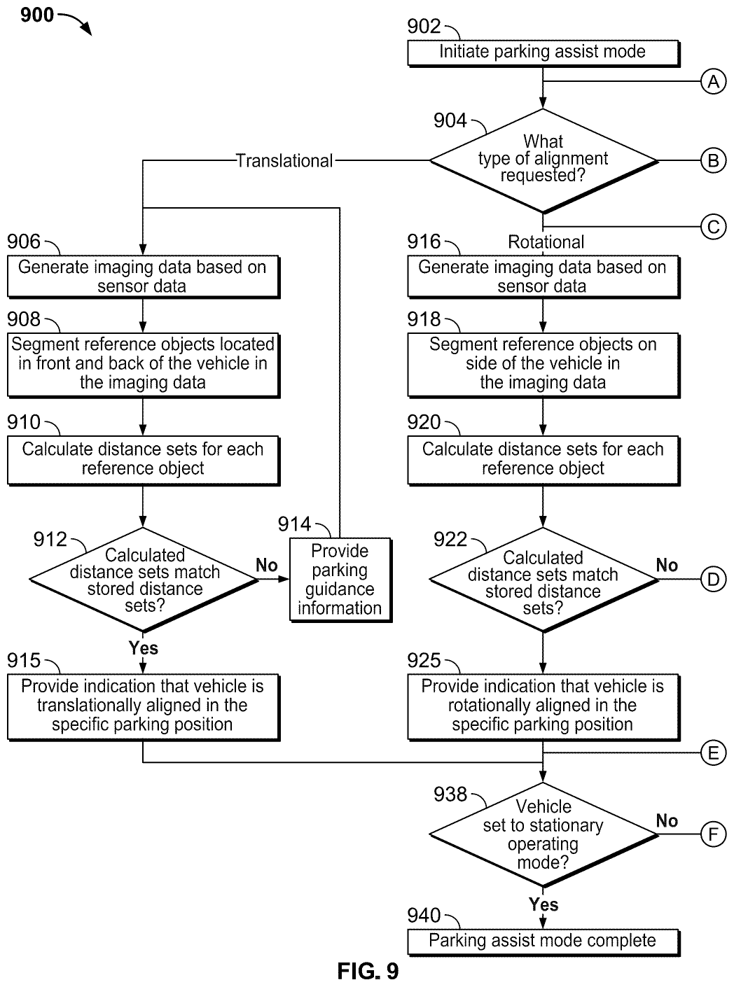

Memory may be an electronic storage device provided as storage 606 that is part of control circuitry 604 (often referred to as an electronic control unit, or ECU). As referred to herein, the phrase “electronic storage device” or “storage device” should be understood to mean any device for storing electronic data, computer software, or firmware, such as random-access memory, read-only memory, hard drives, optical drives, solid state devices, quantum storage devices, or any other suitable fixed or removable storage devices, and/or any combination of the same. Storage 606 may be used to store various types of content described herein. Nonvolatile memory may also be used (e.g., to launch a boot-up routine and other instructions). Cloud-based storage may be used (e.g., such as database 818 of FIG. 8).

In one embodiment, speakers 620 may be provided as integrated with other elements of vehicle architecture 600 or may be stand-alone units. The audio, or any other content displayed on display 614, may be played through speakers 620.

Sensor(s) 622 are used to monitor, identify, and determine vehicular and environment data. For example, the parking assist application may receive imaging data from the sensor(s) 622 or any other vehicular status data (e.g., global positioning data of the vehicle, driving condition of the vehicle, etc.) received from any other vehicular circuitry and/or component that describes the vehicular status of the vehicle. Cameras 624 are used to capture images of the surrounding environment of the vehicle. In some embodiments, control circuitry 604 is configured to generate a spatial mapping of the vehicle's surroundings based on image-based 2D mapping techniques such stereo vision, monocular depth estimation, or photogrammetry. In some embodiments, the cameras are provided as integrated with other elements of vehicle architecture 600.

A parking assist application may be implemented using any suitable architecture. For example, it may be a stand-alone application wholly implemented on vehicle architecture 600. In such an approach, instructions of the application are stored locally (e.g., in storage 606), and data for use by the application is downloaded on a periodic basis (e.g., from an out-of-band feed, from an internet resource, or using another suitable approach). Control circuitry 604 may retrieve instructions of the application from storage 606 and process the instructions to generate any of the interfaces discussed herein. Based on the processed instructions, control circuitry 604 may determine what action to perform when input is received from user input interface 616. For example, movement of a cursor on a user interface element may be indicated by the processed instructions received from user input interface 616.

In some embodiments, the parking assist application is a client/server-based application. Data for use by a thick or thin client implemented on vehicle architecture 600 is retrieved on demand by issuing requests to a server remote to the vehicle architecture 600. In one example of a client/server-based content application, control circuitry 604 runs a web browser that interprets web pages provided by a remote server. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on vehicle architecture 600. This way, the processing of the instructions is performed remotely by the server while the resulting displays are provided locally on vehicle architecture 600. Vehicle architecture 600 may receive inputs from the user or occupant of the vehicle via user input interface 616 and transmit those inputs to the remote server for processing and generating the corresponding displays. For example, vehicle architecture 600 may transmit, via antenna array 618, a communication to the remote server indicating that a user interface element was selected via user input interface 616. The remote server may process instructions in accordance with that input and generate a display of content identifiers associated with the selected user interface element. The generated display is then transmitted to vehicle architecture 600 for presentation to the user or occupant of the vehicle.

In some embodiments, the parking assist application is downloaded and interpreted or otherwise run by an interpreter or virtual machine (executed by control circuitry 604). In some embodiments, the parking assist application may be encoded in the Enhanced TV Binary Interchange Format (EBIF), received by control circuitry 604 as part of a suitable feed, and interpreted by a user agent running on control circuitry 604. For example, the parking assist application may be an EBIF application. In some embodiments, the parking assist application may be defined by a series of JAVA-based files that are received and run by a local virtual machine or other suitable middleware executed by control circuitry 604.

Vehicle architecture 600 of FIG. 6 can be implemented in system 700 of FIG. 7 as vehicle 706. The parking assist application may be implemented on user devices 704, 708, 710, vehicle 706 or any other type of user equipment suitable for mapping a parking environment and providing parking guidance information. For simplicity, these devices may be referred to herein collectively as user equipment or user equipment devices and may be substantially similar to user equipment devices described above. User equipment devices may function as stand-alone devices or may be part of a network of devices. Various network configurations of devices may be implemented and are discussed in more detail below.

In some embodiments, the system may also include a separate user equipment device. The user equipment device may be configured to have many of the same features and complete similar tasks to vehicle architecture 600. For example, the parking assist application may also be implemented on the user equipment device which may be communicatively coupled to vehicle architecture 600. A user may initiate parking configuration mode, initiate parking assist mode, make selections of potential reference objects, and receive parking guidance information using the user input interface of the user equipment device. When the control circuitry of the user equipment device processes an input from the user using the parking assist application it may transmit a command corresponding to that input to vehicle architecture 600 using its own Antenna Array. In some embodiments, the parking assist application may use camera(s) and sensor(s) of the user equipment device to capture spatial data and other parking environment data around the vehicle.

FIG. 7 is an example of an illustrative system implementing the user equipment device, in accordance with embodiments of the disclosure. A user equipment device utilizing at least some of the system features described above in connection with FIG. 7 may not be classified solely as vehicle 706 or a user device 704, 708, 710. For example, vehicle 706 may be remotely controlled via user devices 704, 708, 710.

The user equipment devices may be coupled to communication network 702. Communication network 702 may be one or more networks including the internet, a mobile phone network, mobile voice or data network (e.g., a 4G, 5G or LTE network), a vehicle-to-vehicle (V2V) network, or other types of communication networks or combinations of communications networks.

System 700 includes data source 703 and user devices 704, 706, 708, 710 coupled to communication network 702. Communications with the data source 703 and the user equipment devices may be exchanged over one or more communication paths. In some embodiments, the user equipment devices exchange communications with the computer equipment of other nearby vehicles over one or more communication paths.

Data source 703 may include one or more types of content distribution equipment including a media distribution facility, satellite distribution facility, programming sources, intermediate distribution facilities and/or servers, internet providers, on-demand media servers, and other content providers. In some embodiments, the user equipment devices access the data source 703 to receive parking assist data. In some approaches, data source 703 may be any suitable server configured to provide any information needed for operation of the user equipment devices as described above and below (e.g., in FIGS. 1-6). For example, data source 703 may provide weather information, environment information, data about vehicle capabilities, and/or any other suitable data needed for operations of user equipment devices (e.g., as described in FIGS. 1-9). In some implementations, parking assist data may be provided to the user devices 704, 708, 710 or vehicle 706 from the data source 703, which can be done using any suitable approach (e.g., a client/server approach). For example, the user equipment devices may pull parking assist data from a server, or a server may present the parking assist data to the user equipment devices. Data source 703 may provide the user equipment devices the parking assist application itself or software updates for the parking assist application.

In some embodiments, the user equipment devices, which include the control circuitry 604, the I/O path 602, and storage 606, communicate over the communication network 702 with a server 712 to send and receive vehicle diagnostic data (e.g., data related to the vehicle's performance and internal systems, safety-related data (e.g., data related to vehicle speed or braking, especially in the event of a collision), GPS and map data, trained machine learning models the user equipment devices implements (e.g., analyzing external environment, or processing images), stored location data of parking reference objects, stored imaging data of a particular parking environment, and any other necessary data. In some approaches, the user equipment devices send data (e.g., data collected from vehicular sensors or saved color patterns) back to server 712, which server 712 stores in database 714.

In some embodiments, server 712 may include control circuitry 716 and storage 720 (e.g., RAM, ROM, Hard Disk, Removable Disk, etc.). Storage 720 may store one or more databases. Server 712 may also include an input/output path 718. I/O path 718 may provide media consumption data, social networking data, device information, or other data, over a local area network (LAN) or wide area network (WAN), and/or other content and data to control circuitry 716, which may include processing circuitry, and storage 720. Control circuitry 716 may be used to send and receive commands, requests, and other suitable data using I/O path 718, which may comprise I/O circuitry. I/O path 718 may connect control circuitry 716 (and specifically control circuitry) to one or more communications paths. I/O path 718 may comprise I/O circuitry.

FIG. 8 is a sequence diagram of the transfer of instructions between a user and a vehicle's parking assist system during parking configuration mode, in accordance with embodiments of the disclosure. Process 800 shown by FIG. 8 includes user 802 and parking assist system 804. At 806, user 802 provides an indication (e.g., via a user input on user input interface 616 of FIG. 6) to parking assist system 804 to enter parking configuration mode. At 808, the parking assist system begins collecting vehicle sensor data (e.g., via camera(s) 622 and/or sensor(s) 624 of FIG. 6). The captured sensor data may be depth data, distance data, 3D mapping data, image data or any other type of suitable sensor data.

At 810, user 802 switches the vehicle to a stationary drive setting (e.g., sets vehicle to park or turns off engine). In some embodiments, 810 may occur before 806 (i.e., the user parks their car and then requests to initiate parking configuration mode). Switching the vehicle to a stationary drive setting indicates to parking assist system 804 that it should store the current alignment of the vehicle in its current specific parking position. To store the current alignment of the vehicle, the parking assist system loops through 812 to 822 for each vehicle side. At 812, parking assist system 804 generates imaging data for a particular side based on the collected sensor data. The imaging data may be a 3D spatial map, a 2D image, or any other suitable imaging data. Then, at 814, parking assist system 804 presents (e.g., via display 614 of FIG. 6) a parking environment representation (generated using the imaging data) of the particular vehicle side to enable user 802 to select stationary objects to be used as reference objects for the vehicle's alignment in its specific parking position.

At 816, user 802 selects (e.g., via user inputs on user input interface 616 of FIG. 6) the objects within the parking environment representation that parking assist system 804 should use as reference objects on that particular side of the vehicle. Parking assist system 804 may then, at 818, segment the selected reference objects from the imaging data. For each segmented reference object, parking assist system 804 calculates distances to particular portions of the reference object at 820. For example, as disclosed in the description of FIGS. 2A-2B, some embodiments involve parking assist system 804 measuring a normal distance and an offset distance between a particular portion of the vehicle (e.g., the location of a vehicle sensor) and a notable portion of the reference object (e.g., the center of the reference object). In some embodiments, the parking assist system segments all possible reference objects at 818 before user 802 selects the particular objects to be used as reference objects at 816.

At 822, parking assist system 804 stores the imaging data including the segmented reference objects along with the calculated distance sets (e.g., normal and offset distance to an object) which help the parking assist system 804 define the vehicle's current alignment at its specific parking position. Parking assist system 804 moves to 824 when it has completed the loop from 814 to 822 for every side of the vehicle. At 824, parking assist system 804 indicates to user 802 that parking configuration mode is complete.

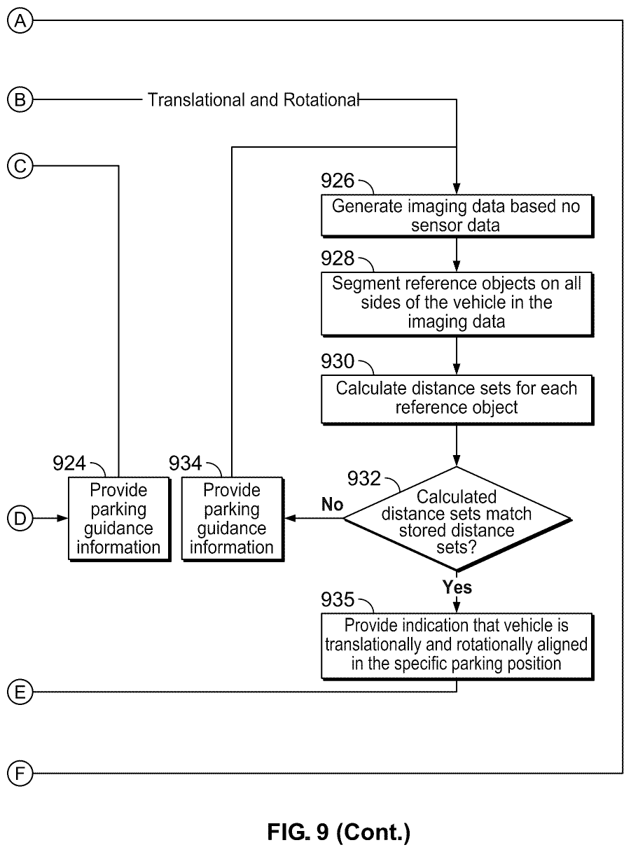

FIG. 9 is an illustrative flowchart for a process of aligning a vehicle into a specific parking position during parking assist mode, in accordance with embodiments of the disclosure. In various embodiments, the individual steps of process 900 may be implemented by one or more components of the devices and systems of FIGS. 1-7. Although the present disclosure may describe certain steps of process 900 (and of other processes described herein) as being implemented by certain components of the devices and systems of FIGS. 1-7, this is for purposes of illustration only, and it should be understood that other components of the devices and systems of FIGS. 1-7 may implement those steps instead.

Process 900 begins at step 902, where control circuitry (e.g., control circuitry 604 of FIG. 6) initiates parking assist mode (e.g., using CPU 608). In some embodiments, control circuitry initiates parking assist mode based on determining that the vehicle is in proximity of a parking environment that has previously been configured for a specific parking position during parking configuration mode. For example, control circuitry may determine that the vehicle GPS location is a threshold distance from the stored GPS location (e.g., stored at storage 606 of FIG. 6 and/or storage 720 of FIG. 7) of the parking environment and/or may detect similarities between the current imaging data of the vehicle's environment to a stored historical imaging data of the parking environment. In some embodiments, control circuitry initiates parking assist mode based on receiving a user request (e.g., via a user input on user input interface 616 of FIG. 6) to initiate parking assist mode.

At step 904, control circuitry (e.g., control circuitry 604 of FIG. 6) determines what type of alignment it must achieve in order to successfully perform parking assist mode (e.g., using CPU 608 of FIG. 6). For example, the parking assist application running on the control circuitry can be configured to monitor for translational alignment, angular alignment, or both alignments with respect to the specific parking position. Steps 906 to 914 outline the steps for aligning the vehicle translationally to the specific parking position alignment. Steps 916 to 924 outline the steps for angularly aligning the vehicle to the specific parking position alignment. Steps 926 to 934 outline the steps for aligning the vehicle translationally and angularly to the specific parking position alignment.

At steps 906, 916, 926, control circuitry (e.g., control circuitry 604 of FIG. 6) generates (e.g., using GPU 610 of FIG. 6) imaging data (e.g., a 3D spatial map, a 2D image, or any other suitable representation of the parking environment) based on sensor data (e.g., aggregated via SFPU 612 of control circuitry 604 of FIG. 6). By leveraging the imaging data and referencing known reference objects from the imaging data stored during parking configuration mode, control circuitry is enabled to quickly identify the reference objects within the parking environment during parking assist mode.

At steps 908, 918, 928, control circuitry (e.g., control circuitry 604 of FIG. 6) segments the reference objects located at a particular side of the vehicle from the imaging data. In some embodiments, control circuitry determines which reference objects to segment based on the type of alignment that is required (e.g., using GPU 610 of FIG. 6). For example, to accurately determine angular alignment, control circuitry segments the reference objects located on the sides of the vehicle. Conversely, to accurately determine translation alignment, control circuitry segments the reference objects on the front and back of the vehicle. Lastly, when determining both angular and translational alignment, control circuitry segments reference objects from all sides of the vehicle where a reference object is located.

At steps 910, 920, 930, control circuitry (e.g., control circuitry 604 of FIG. 6) calculates distance sets (e.g., using GPU 610 of FIG. 6) between notable portions of the reference object and particular portions of the vehicle (e.g., the location of the vehicle sensors). In some embodiments, the notable portions of the object are edges, corners, landmarks (e.g., unique or high-contrast points of the object), surface centers, or any other suitable portions of the object to accurately measure distance from. In some embodiments, as disclosed in the description of FIGS. 2A-2B, the distance sets may correspond to or be a basis for a normal distance, and an offset distance between a particular portion of the vehicle and a notable portion of the reference object. In some embodiments, as disclosed in the description of FIGS. 3A-3B, control circuitry may calculate location sets corresponding to the location of particular portions of the vehicle with respect to a respective reference object.

At steps 912, 922, 932, control circuitry (e.g., control circuitry 604 of FIG. 6) determines whether the calculated distance sets for each reference object match or are within a threshold similarity to stored distance sets (e.g., using GPU 610 of FIG. 6). In some embodiments, the stored distance sets were stored during parking configuration mode and therefore provide a precise indication for whether the vehicle is aligned in the specific parking position. If the vehicle is not aligned in the specific parking position, the difference between the calculated distance sets and stored distance sets indicates how misaligned the vehicle is and how the vehicle must maneuver to achieve alignment.

If at steps 912, 922, 932 the control circuitry (e.g., control circuitry 604 of FIG. 6) determines that the calculated distance sets for each reference object do not match or are not within a threshold similarity to stored distance sets, control circuitry moves to steps 914, 924, and 934 respectively (e.g., using GPU 610 of FIG. 6). At steps 914, 924, 934, control circuitry (e.g., control circuitry 604 of FIG. 6) provides parking guidance information that indicates a suggested trajectory the vehicle should take to achieve alignment into the specific parking position. In some embodiments, the parking guidance information is displayed as visual cues (e.g., via display 614 of FIG. 6), as audio cues (e.g., via speakers 620 of FIG. 6), or any other suitable form of parking guidance information. From step 914 control circuitry then repeats steps 906, 908, 910; 912, respectively to ensure that the calculated distance sets match or are within a threshold distance of the stored distance sets (i.e., the vehicle is translationally aligned in the specific parking position). From step 924, control circuitry repeats steps 916, 918, 920, 922 (i.e., to ensure that the vehicle is rotationally aligned). From step 934, control circuitry repeats steps 926, 928, 930, 932 (i.e., to ensure that the vehicle is translationally and rotationally aligned).

If at steps 912, 922, 932 the control circuitry (e.g., control circuitry 604 of FIG. 6) determines that the calculated distance sets for each reference object do match or are within a threshold similarity to stored distance sets (e.g., using GPU 610 of FIG. 6), control circuitry moves to steps 915, 925, and 935 respectively. At steps 915, 925, 935, control circuitry (e.g., control circuitry 604 of FIG. 6) provides an indication (e.g., a haptic cue, a visual cue via display 614 of FIG. 6, or an audio cue via speakers 620 of FIG. 6) that the vehicle is aligned in the specific parking position (e.g., either translationally, angularly, or both).

At step 938, control circuitry (e.g., control circuitry 604 of FIG. 6) determines whether the vehicle has been set to a stationary drive setting after completing at least one of steps 915, 925, 935 (e.g., using CPU 608 of FIG. 6). For example, if control circuitry determines that the vehicle has been set to park and/or turned off the motor, the control circuitry determines that the vehicle has reached sufficient alignment within the parking environment. Based on the vehicle being in a stationary drive setting and the subsequent determination, control circuitry moves to step 940 and ends parking assist mode.

In some embodiments, however, control circuitry concludes that the vehicle has not entered a stationary drive setting. For example, the parking assist mode may have only been set to angularly align the vehicle, and the vehicle may continue to receive driving inputs to maneuver the vehicle into translational alignment. In such embodiments, where, at step 938, the vehicle is determined not to be in a stationary operating state, control circuitry returns to step 904 to repeat one of steps 906 to 915, 916 to 925, or 926 to 935.

The embodiments discussed above are intended to be illustrative and not limiting. Only the claims that follow are meant to set bounds as to what the present invention includes. Furthermore, it should be noted that the feature and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also not be noted that the systems and/or methods described above may be applied to, or used in accordance with, other systems and/or methods.

1. A method comprising:
initiating, at a first time, parking configuration mode for a vehicle parked in a first position in a parking area;
generating for display, on a user interface of a device, at least one representation of a physical environment of the parking area, based on sensor data captured by at least one sensor;
receiving, via the user interface, a selection of a one or more objects from the at least one representation of the physical environment of the parking area to be used as parking reference points for future parking of the vehicle in the first position;
determining and causing to be stored first distance data based on a first set of distances, wherein each respective distance of the first set of distances corresponds to a distance from the vehicle in the first position to a respective object of the one or more objects in the parking area;
initiating, at a second time, parking assist mode for assisting in parking the vehicle in the first position;
determining second distance data based on a second set of distances, wherein each respective distance of the second set of distances corresponds to a distance from the vehicle in a second position to a respective object of the one or more objects in the parking area; and
based at least in part on comparing (a) the second distance data determined in the parking assist mode at the second time and (b) the stored first distance data generated in the parking configuration mode at the first time:
generating for output, guidance information for parking the vehicle in the first position.

2. The method of claim 1, further comprising:
causing to be stored, during the parking configuration mode, location data that is based on geographical coordinates of the parking area, wherein the parking assist mode is initiated based at least in part on:
determining, based on the geographical coordinates of the parking area, that the vehicle is within a proximity of the parking area.

3. The method of claim 1, wherein the guidance information comprises recommended driving directions for repositioning the vehicle from the second position to the first position within the parking area.

4. The method of claim 3, wherein the vehicle is an autonomous vehicle, and wherein the autonomous vehicle is configured to automatically follow the recommended driving directions to reposition the vehicle from the second position to the first position within the parking area.

5. The method of claim 1, wherein the comparing (a) the second distance data determined in the parking assist mode at the second time and (b) the stored first distance data generated in the parking configuration mode at the first time comprises:
comparing a front distance stored at the first time with a front distance determined at the second time, wherein each of the front distances corresponds to a distance from a front sensor of the vehicle to a respective object of the one or more objects in the parking area;
comparing a back distance stored at the first time with a back distance determined at the second time, wherein each of the back distances corresponds to a distance from a back sensor of the vehicle to a respective object of the one or more objects in the parking area;
comparing a side distance stored at the first time does not with a side distance determined at the second time, wherein each of the side distances corresponds to a distance from a side sensor of the vehicle to a respective object of the one or more objects in the parking area.

6. The method of claim 5, further comprising:
determining based on the comparing that the vehicle is positioned with an angular displacement that is different from an angular displacement at the first time; and
generating for output the guidance information for changing the angular displacement of the vehicle.

7. The method of claim 1, further comprising:
detecting the one or more objects in the physical environment of the parking area;
determining that the one or more objects are static objects;
wherein the generating for display on the user interface of the device at least one representation of the physical environment of the parking area comprises:
generating a respective AR overlay over at least a portion of each respective object of the one or more objects to indicate that the one or more objects are static objects that are candidates for being used as parking reference points.

8. The method of claim 7, wherein the detecting the one or more objects in the physical environment of the parking area and determining that the one or more objects are static objects is performed based on:
comparing the locations of the one or more objects in the physical environment of the parking are at various times using historical image data.

9. The method of claim 7, wherein the receiving, via the user interface, the selection of the one or more objects from the at least one representation of the physical environment of the parking area further comprises:
receiving a request, via the user interface, to reduce the respective AR overlay over a particular object, wherein reducing the respective AR overlay causes the parking reference point for the particular object to change to a part of the particular object covered by the reduced AR overlay.

10. The method of claim 7, further comprising:
determining that a particular object of the one or more objects determined to be a static object is obstructed; and
generating the respective AR overlay over an unobstructed portion of the particular object.

11. The method of claim 10, wherein a distance between the particular object and the vehicle is determined based on the unobstructed portion of the particular object.

12. The method of claim 1, further comprising:
determining, at the second time, that a reference point of a particular object which was unobstructed during the parking configuration mode is now obstructed during the parking assist mode;
detecting an unobstructed portion of the particular object as an alternative reference point;
based on the first distance data, calculating a distance between the unobstructed portion of the particular object and the vehicle when parked at the first position; and
adding the calculated distance to the first distance data.

13. The method of claim 1, wherein the vehicle is a first vehicle, the method further comprising:
storing third distance data corresponding to a third position wherein the third distance data is stored in association with a second vehicle, wherein the first position is accessible through a first garage door and the third position is accessible through a second garage door, the method further comprising:
based on determining that the first vehicle is in a proximity of the first position, causing the first garage door to open;
based on determining that the second vehicle is in a proximity of the third position, causing the second garage door to open.

14. A system comprising:
control circuitry configured to:
initiate, at a first time, parking configuration mode for a vehicle parked in a first position in a parking area;
generate for display, on a user interface of a device, at least one representation of a physical environment of the parking area, based on sensor data captured by at least one sensor;
input/output circuitry configured to:
receive, via the user interface, a selection of a one or more objects from the at least one representation of the physical environment of the parking area to be used as parking reference points for future parking of the vehicle in the first position;
wherein the control circuitry is further configured to:
determine and cause to be stored first distance data based on a first set of distances, wherein each respective distance of the first set of distances corresponds to a distance from the vehicle in the first position to a respective object of the one or more objects in the parking area;
initiate, at a second time, parking assist mode for assisting in parking the vehicle in the first position;
determine second distance data based on a second set of distances, wherein each respective distance of the second set of distances corresponds to a distance from the vehicle in a second position to a respective object of the one or more objects in the parking area; and
based at least in part on comparing (a) the second distance data determined in the parking assist mode at the second time and (b) the stored first distance data generated in the parking configuration mode at the first time:
generate for output, guidance information for parking the vehicle in the first position.

15. The system of claim 14, wherein the control circuitry is further configured to:
cause to be stored, during the parking configuration mode, location data that is based on geographical coordinates of the parking area, wherein the parking assist mode is initiated based at least in part on:
determine, based on the geographical coordinates of the parking area, that the vehicle is within a proximity of the parking area.

16. The system of claim 14, wherein the guidance information comprises recommended driving directions for repositioning the vehicle from the second position to the first position within the parking area.

17. The system of claim 16, wherein the vehicle is an autonomous vehicle, and wherein the autonomous vehicle is configured to automatically follow the recommended driving directions to reposition the vehicle from the second position to the first position within the parking area.

18. The system of claim 14, wherein the control circuitry is configured to compare (a) the second distance data determined in the parking assist mode at the second time and (b) the stored first distance data generated in the parking configuration mode at the first time by:
comparing a front distance stored at the first time with a front distance determined at the second time, wherein each of the front distances corresponds to a distance from a front sensor of the vehicle to a respective object of the one or more objects in the parking area;
comparing a back distance stored at the first time with a back distance determined at the second time, wherein each of the back distances corresponds to a distance from a back sensor of the vehicle to a respective object of the one or more objects in the parking area;
comparing a side distance stored at the first time does not with a side distance determined at the second time, wherein each of the side distances corresponds to a distance from a side sensor of the vehicle to a respective object of the one or more objects in the parking area.

19. The system of claim 18, wherein the control circuitry is further configured to:
determine based on the comparing that the vehicle is positioned with a current angular displacement that is different from an angular displacement at the first time; and
generate for output the guidance information for changing the angular displacement of the vehicle.

20. The system of claim 14, wherein the control circuitry is further configured to:
detect the one or more objects in the physical environment of the parking area;
determine that the one or more objects are static objects;
wherein the control circuitry is configured to generate for display on the user interface of the device at least one representation of the physical environment of the parking area by:
generating a respective AR overlay over at least a portion of each respective object of the one or more objects to indicate that the one or more objects are static objects that are candidates for being used as parking reference points.

21-65. (canceled)
